(19) United States
(12) Patent Application Publication
(10) Pub. No.: US 2022/0097448 A1
(43) Pub. Date: Mar. 31, 2022

(54) SCULPTURE IN THREE-DIMENSIONAL TRANSPARENT SPACE, AND METHOD FOR PRODUCING SAME

(71) Applicants: Sung Bae LEE, Daejeon (KR); Jung Sook JUNG, Daegu (KR)

(72) Inventors: Sung Bae LEE, Daejeon (KR); Jung Sook JUNG, Daegu (KR)

(21) Appl. No.: 17/298,201

(22) PCT Filed: Nov. 28, 2019
(86) PCT No.: PCT/KR2019/016531

§ 371 Date: May 28, 2021

(30) Foreign Application Priority Data
Nov. 29, 2018 (KR) 10-2018-0151367

(51) Int. Cl. B44F 1/06; B44C 3/02

(52) U.S. Cl. CPC B44F 1/06; B44C 3/025

(57) ABSTRACT

The present disclosure relates to a technology of producing a sculpture in a 3D stereoscopic space filled with a transparent material. The sculpture may be produced through a process of preparing a desired number of 2D plans acquired by dividing a 3D plan of the sculpture and a plurality of transparent plates corresponding to the number of the 2D plans, forming the shapes of corresponding regions by stacking representation materials on the corresponding transparent plates, joining the representation materials to the corresponding transparent plates, or making scratches on the corresponding transparent plates, and stacking the transparent plates having the shapes formed thereon, and can precisely represent shapes through various representation techniques or be repeatedly reproduced.

### CROSS-REFERENCE TO RELATED APPLICATION(S)

This application is a national entry of International Application No. PCT/KR2019/016531, filed on Nov. 28, 2019, which claims under 35 U.S.C. § 119(a) and 365(b) priority to and benefits of Korean Patent Application No. 10-2018-0151367, filed on Nov. 29, 2018 in the Korean Intellectual Property Office, the entire contents of which are incorporated herein by reference.

### TECHNICAL FIELD

The present disclosure relates to a sculpture produced in a three-dimensional (3D) stereoscopic space filled with a transparent material, and particularly, to a sculpture in a 3D transparent space, which is produced in a desired shape by using a desired number of 2D plans, acquired by dividing a 3D plan of a sculpture to be produced, and a plurality of transparent plates corresponding to the number of the 2D plans, and a method for producing the same.

### BACKGROUND ART

There may be various methods for representing a certain shape. Examples of the methods may include a letter represented as a one-dimensional (1D) shape by a line, a picture represented as a second-dimensional (2D) shape on a plane, and a sculpture three-dimensionally represented as a 3D shape. The representation ranges of letter, picture and sculpture have a relationship of (letter>picture>sculpture). In reality, however, it feels like the representation ranges of letter, picture and sculpture have a relationship of (sculpture>picture>letter).

Examples of a representation material of letter may include a bamboo pole or wood tablet which is not so used in these days, but had been conventionally used for a long time, examples of a representation material of picture may include a paper, plate or the like, and examples of a representation space of sculpture may include a transparent space. The representation material of letter, the representation material of picture and the representation space of sculpture may indicate materials and spaces which can be easily carried by a human without using transportation equipment. For example, the representation material of letter, the representation material of picture and the representation space of sculpture do not include materials which are impossible to carry, such as a huge rock engraved with letters, a huge cave having a picture drawn therein, and a sculpture which is fixedly installed outside and has a volume or weight equal to or more than a predetermined value.

A bamboo pole or wood tablet used as a 1D representation material has a limitation in representation, because the bamboo pole or wood tablet can simply represent only a 1D image such as a letter. Although a 2D image such as a picture is represented on the bamboo pole or wood tablet, the representation is extremely limited.

A paper or plate used as a 2D representation material can represent both a 1D image such as letter and a 2D image such as picture, but has a limitation in three-dimensionally representing a 3D image.

On the contrary, the 3D sculpture can represent all of 1D to 3D images, and thus have power of representation, which is much better than the 1D or 2D representation material.

Examples of a conventional image representation technology may include a 3D laser engraving method that makes dot-shaped scratches by emitting laser beams into a transparent crystal stereoscopic space, and forms a desired shape (e.g. human face or object) by combining the dot-shaped scratches.

According to another conventional image representation technology based on the patent for which the application was filed by the applicant of the present disclosure and which has been registered, a letter, picture, internal sculpture and genuine article, and a transparent binder serving as a fixing unit or a transparent carrier serving as a carrying unit are applied to produce a sculpture in a desired shape.

However, such a conventional 3D laser engraving technology cannot represent a shape in color, but can simply represent a shape only in black. Furthermore, the conventional 3D laser engraving technology cannot use other materials, and thus have a limitation of simple representation.

Furthermore, the another conventional image representation technology hardly represents or cannot represent a complex image such as dense foliage, and has no or extremely low repeatability or reproducibility.

### DISCLOSURE

### Technical Problem

Various embodiments are directed to a sculpture which is produced through a process of preparing a desired number of 2D plans acquired by dividing a 3D plan of the sculpture and a plurality of transparent plates corresponding to the number of the 2D plans, forming the shapes of corresponding regions by stacking representation materials on the corresponding transparent plates, joining the representation materials to the corresponding transparent plates, or making scratches on the corresponding transparent plates, and stacking the transparent plates having the shapes formed thereon, and can precisely represent shapes through various representation techniques or be repeatedly reproduced.

Also, various embodiments are directed to a method for producing a sculpture which is produced through a process of preparing a desired number of 2D plans acquired by dividing a 3D plan of the sculpture and a plurality of transparent plates corresponding to the number of the 2D plans, forming the shapes of corresponding regions by stacking representation materials on the corresponding transparent plates or making scratches on the corresponding transparent plates, and stacking the transparent plates having the shapes formed thereon, and can precisely represent shapes through various representation techniques or be repeatedly reproduced.

### Technical Solution

In an embodiment, a sculpture in a 3D transparent space may include: a plurality of transparent plates produced to correspond to N 2D plans acquired by dividing a 3D plan of a sculpture, which is to be produced, in a random direction, respectively, such that the shapes of the corresponding regions of the sculpture are formed and stacked on the respective transparent plates; one or more representation materials selected from a representation material stacked on the corresponding transparent plate so as to form the shape of the corresponding region on the corresponding transparent plate, a representation material to be joined, and a representation material of a scratch formed to represent the shape; a plurality of transparent supports each fixedly installed on one side of the corresponding transparent plate so as to stack the transparent plate; a containing frame made of a transparent material, and configured to contain components of the sculpture having the transparent plates stacked therein; and a transparent material filling the internal space of the containing frame.

In another embodiment, a method for producing a sculpture in a 3D transparent space may include: (a) preparing a 3D plan of a sculpture; (b) acquiring N 2D plans by dividing the 3D plan in a horizontal direction; (c) preparing a plurality of transparent plates corresponding to the number of the N 2D plans; (d) forming the shapes of the 2D plans on the respective transparent plates using a representation material, while stacking the N transparent plates; and (e) putting components of the sculpture, subjected to the shape formation process, into a containing frame, and filling the empty space of the containing frame with a transparent material.

### Advantageous Effects

In accordance with the embodiment of the present disclosure, the sculpture can be produced through the process of preparing a desired number of 2D plans acquired by dividing a 3D plan of the sculpture and a plurality of transparent plates corresponding to the number of the 2D plans, forming the shapes of corresponding regions by stacking representation materials on the corresponding transparent plates, joining the representation materials to the corresponding transparent plates, or making scratches on the corresponding transparent plates, and stacking the transparent plates having the shapes formed thereon. Thus, it is possible to precisely represent a sculpture with a complex and precise structure through various representation techniques.

Furthermore, since the sculpture is produced based on the 2D plans acquired by dividing the 3D plan of the sculpture and the transparent plates corresponding to the number of the 2D plans, the reproducibility may be improved.

Furthermore, since most natural material and most artificial materials can be used to produce the sculpture, the sculpture can be represented in various manners.

### BRIEF DESCRIPTION OF DRAWINGS

FIG. 1 is a perspective view illustrating a sculpture in a 3D transparent space in accordance with an embodiment of the present disclosure.

FIGS. 2A to 2C are cross-sectional views each illustrating an example in which the shape of a corresponding region is formed on a transparent plate, in accordance with the embodiment of the present disclosure.

FIG. 3 is a flowchart illustrating a method for producing a sculpture in a 3D transparent space in accordance with an embodiment of the present disclosure.

FIG. 4 is a 3D diagram illustrating a sculpture which is to be produced in accordance with an embodiment of the present disclosure.

FIG. 5 is a diagram illustrating a process of forming, on transparent plates, the shapes corresponding to the respective 2D plans, while stacking the transparent plates, in accordance with the embodiment of the present disclosure.

FIG. 6 is a perspective view illustrating a containing frame which is applied to the present disclosure.

FIG. 7 is a perspective view illustrating a sculpture which is produced of sand, in accordance with the embodiment of the present disclosure.

### MODE FOR INVENTION

Hereafter, exemplary embodiments of the present invention will be described in detail with reference to the accompanying drawings.

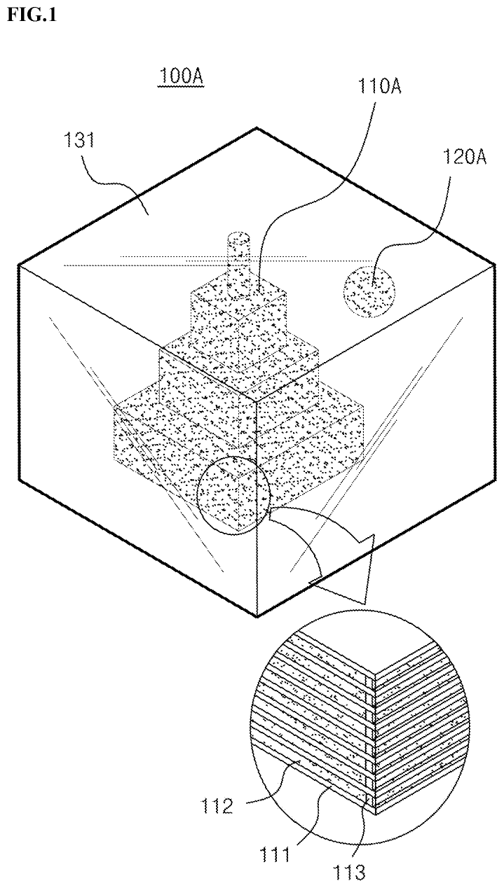

FIG. 1 is a perspective view illustrating a sculpture in a 3D transparent space in accordance with an embodiment of the present disclosure. As illustrated in FIG. 1, a sculpture 100A includes a plurality of transparent plates 111, a plurality of representation materials 112, a plurality of transparent supports 113 and a containing frame 131. The plurality of transparent plates 111 are configured so that a 3D plan of the sculpture 100A to be produced corresponds to N 2D plans acquired by dividing the 3D plan in a random direction, and the shapes of corresponding regions of the sculpture 100A are formed and stacked on the respective transparent plates 111. The plurality of representation materials 112 are stacked on the respective transparent plates 111, joined to the respective transparent plates 111, or scratched or cut in such a shape that the shapes of the corresponding regions are formed on the respective transparent plates 111. The transparent support 113 is fixedly installed on one side of the corresponding transparent plate 111 in order to stack the transparent plates 111. The containing frame 131 is formed of a transparent material and contains components of the sculpture in which the transparent plates 111 are stacked.

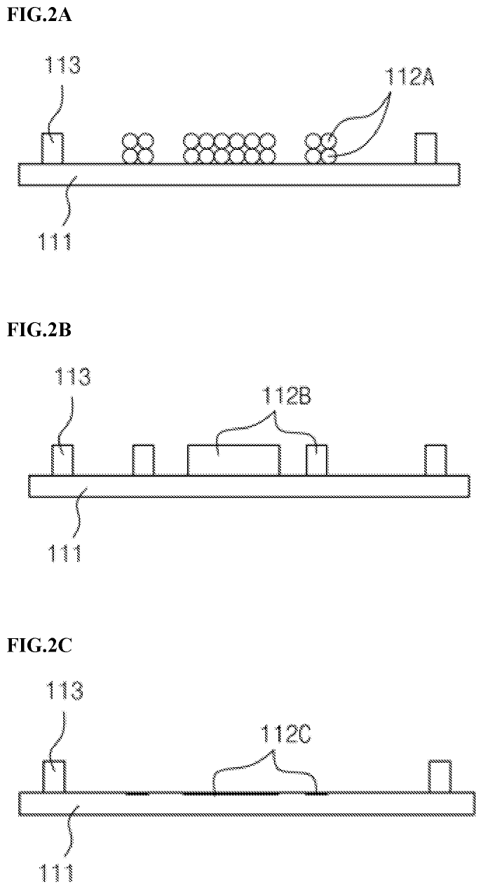

FIGS. 2A to 2C are cross-sectional views each illustrating an example in which the shape of a corresponding region is formed on the transparent plate 111, in accordance with the embodiment of the present disclosure. Referring to FIGS. 1, 2A and 2B, the sculpture in the 3D transparent space in accordance with the embodiment of the present disclosure will be described as follows.

FIG. 1 illustrates the sculpture 100A which is produced in accordance with the embodiment of the present disclosure. Specifically, FIG. 1 is a perspective view illustrating a sculpture which is produced of a representation material such as sand and represents a scene in which there is a full moon 120A over a stone tower 110A, and including a partially expanded view.

The N 2D plans are acquired by dividing the 3D plan of the sculpture 100A to be produced in a random direction (e.g. a vertical, horizontal or diagonal direction), and the transparent plate 111 is a plate made of a transparent material according to the 2D plans. The material of the transparent plate 111 is not particularly limited, but a transparent or semi-transparent material may be used as the material of the transparent plate 111. For example, an acrylic material (resin) may be used as the material of the transparent plate 111.

The representation material 112 is a material or scratch which is used to form the shape of a corresponding region on the transparent plate 111. That is, on the transparent plates 111 produced in the above-described manner, the shapes of the corresponding regions of the sculpture 100A are formed by the representation materials 112. FIG. 2 illustrates such an example. For example, FIG. 2A illustrates that a shape is formed through a process of stacking representation materials 112A on the transparent plate 111. FIG. 2B illustrates that a shape is formed through a process of joining representation materials 112b to the top of the transparent plate 111, and the process may include printing. FIG. 2C illustrates that a shape is formed through a process of making a scratch 112C on the surface of the transparent plate 111. Examples of the representation material may include various artificial materials (e.g. independent objects made of iron or plastic) artificially produced or natural materials (e.g. plants, minerals or animals) acquired from nature. The representation material 112 in the sculpture 100A of FIG. 1 is sand which is one of the natural materials.

The transparent supports 113 are used to stack the transparent plates 111 after the representation materials 112 are used to form the shapes on the respective transparent plates 111. For this sculpture, the transparent support 113 is fixedly installed on one side of the corresponding transparent plate 111.

The containing frame 131 is a frame for containing the stone tower 110A and the full moon 120A, which are components of the sculpture 100A produced in the above-described manner, and the entire surfaces or one or more surfaces of the containing frame 131 are made of a transparent material. The containing frame 131 in which the stone tower 110A and the full moon 120A are fixedly installed is filled with a transparent material. Examples of the transparent material may include a solid such as resin, a liquid such as water, or a gas such as air. The solid transparent material may include acrylic resin.

In the present embodiment, it has been described that the inside of the sculpture 100A is filled with the transparent plates 111 and the representation materials 112. However, the present disclosure is not limited thereto. For another example, the sculpture 110A may be produced so that only the outside thereof is filled with the transparent plates 111 and the representation materials 112 at a predetermined thickness, and the inside thereof is formed as an empty space. For still another example, the sculpture 100A may be produced so that the transparent plates 111 and the representation materials 112 are separated from the outside and inside of a predetermined portion of the sculpture 100A.

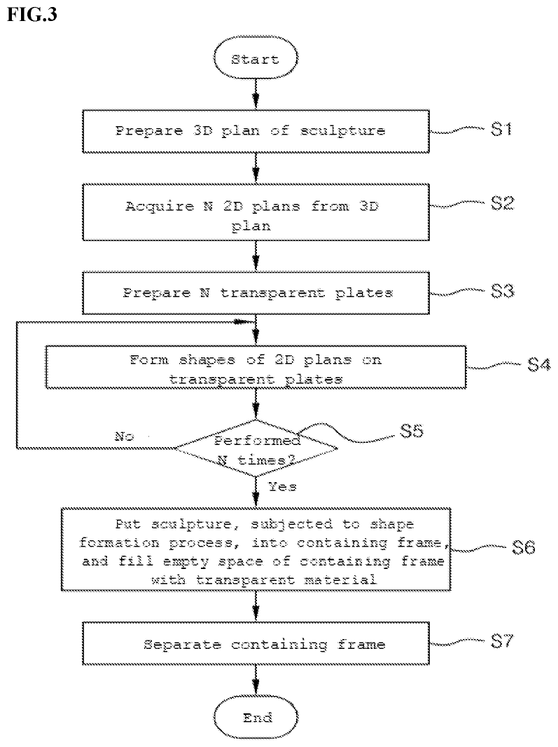

FIG. 3 is a flowchart illustrating a method for producing a sculpture in a 3D transparent space in accordance with an embodiment of the present disclosure. As illustrated in FIG. 3, the method includes step S1 of preparing a 3D plan of a sculpture, step S2 of acquiring N 2D plans by dividing the 3D plan in a random direction, step S3 of preparing a plurality of transparent plates corresponding to the number of the N 2D plans, step S4 of forming the shapes of the corresponding 2D plans on the respective transparent plates while stacking the N transparent plates, steps S5 and S6 of containing components of the sculpture, subjected to the shape formation process, in a containing frame after, and filling the empty space of the containing frame with a transparent material, and step S7 of separating the containing frame.

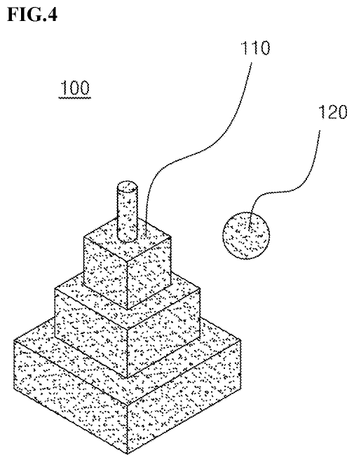

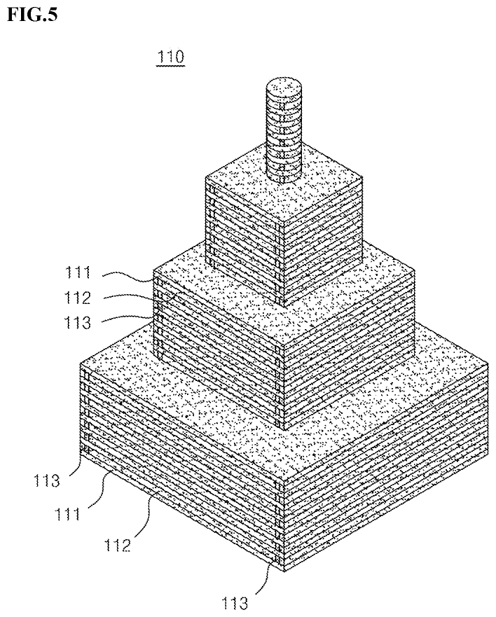

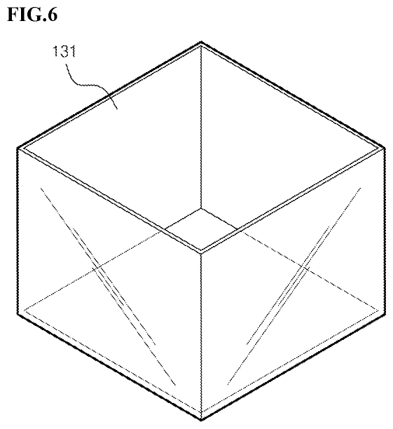

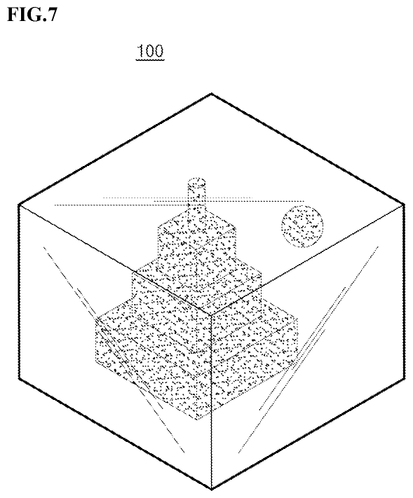

FIG. 4 is a perspective view illustrating a sculpture which is to be produced in accordance with an embodiment of the present disclosure. FIG. 5 is a diagram illustrating the process of forming the shapes of the corresponding 2D plans on the respective transparent plates while stacking the transparent plates acquired by dividing the sculpture of FIG. 4. FIG. 6 is a perspective view illustrating a containing frame which is applied to the present disclosure. FIG. 7 is a perspective view illustrating a sculpture which is produced of a representation material such as sand, in accordance with the embodiment of the present disclosure. Referring to FIGS. 3 to 7, the method for producing a sculpture in a 3D transparent space in accordance with the embodiment of the present disclosure will be described as follows.

First, a 3D plan of a sculpture to be produced is prepared in step S1. FIG. 4 illustrates a 3D plan of a sculpture 100 to be produced in accordance with the embodiment of the present disclosure, the 3D plan showing a scene in which there is a full moon 120 over a stone tower 110. As the method for preparing the 3D plan, various methods may be applied. For example, a 3D plan (3D modeling plan) produced through a computer program for 3D printing may be used, or a 3D plan acquired through a scanner may be used.

The 3D plan of the sculpture 100 is divided N times in a random direction (e.g. horizontal direction) in order to acquire N 2D plans, in step S2. The thicknesses of the N 2D plans acquired by dividing the 3D plan of the sculpture 100 N times in the random direction are not specially limited. For example, the thicknesses of the 2D plans acquired by dividing the 3D plan N times may be equal to or different from one another.

According to the N 2D plans acquired through the division process, N transparent plates 111 are prepared in step S3. The material of the transparent plate 111 is not particularly limited, but a transparent or semi-transparent material may be used. For example, an acrylic material (resin) may be used as the material of the transparent plate 111. With reference to a first 2D plan among the 2D plans acquired by dividing the 3D plan of the sculpture 100, the shape of the first 2D plan is formed on a first transparent plate 111. Then, a process of placing the transparent supports 113 at both edges of the first transparent plate 111, placing the second transparent plate 111 on the transparent supports 113, and then forming the shape of a second 2D plan with reference to the second 2D plan as described above is repeatedly performed a required number of times (N times) in steps S4 and S5.

As the method for forming a desired shape on the transparent plate 111, various methods may be applied. For example, the desired shape may be formed through the method illustrated in FIG. 2. That is, FIG. 2A illustrates that a shape is formed through a process of stacking the representation materials 112A on the transparent plate 111. FIG. 2B illustrates that a shape is formed through a method of joining the representation material 112B to the top of the transparent plate 111 using an adhesive, and the process may include printing. FIG. 2C illustrates that a shape is formed through a process of making the scratch 112C on the surface of the transparent plate 111. Examples of the representation material may include various artificial materials (e.g. independent objects made of iron or plastic) artificially produced or natural materials (e.g. plants, minerals or animals) acquired from nature. FIG. 5 illustrates a process of forming a desired shape on the transparent plate 111 by using sand as a representation material. As the method of making the scratch 112C on the surface of the transparent plate 111, various methods may be applied and may include a method using a laser device, for example.

As another example of the method of forming a desired shape on the transparent plate 111, a 3D printing process by a 3D printer may be applied. The 3D printing process, which is suitable for precise representation, may be performed on the entire N transparent plates 111, performed on some transparent plates 111 among the N transparent plates 111, or performed on a partial region of one transparent plate 111.

The components of the sculpture 100 subjected to the above-described shape formation process are put into the transparent containing frame 131 illustrated in FIG. 6, and the empty space of the transparent containing frame 131 is filled with a transparent material, in step S6.

Through step S6, holes in components of the sculpture 100 subjected to the above-described shape formation process, and the gaps between the components and the containing frame 131 are filled with the transparent material. The transparent material is not particularly limited, and any one of acrylic resin, water and air may be used.

As a post process, the containing frame 131 is separated in step S7.

When the transparent material is a solid such as the acrylic resin, the containing frame 131 may be separated or used as it is. When the transparent material is a liquid or gas, the containing frame 131 needs to be not separated but used as it is.

FIG. 7 illustrates the sculpture in the 3D transparent space, which is completely produced through step S7 corresponding to the finish process.

While various embodiments have been described above, it will be understood to those skilled in the art that the embodiments described are by way of example only. Accordingly, the disclosure described herein should not be limited based on the described embodiments.

1. A sculpture in a 3D transparent space, comprising:
a plurality of transparent plates produced to correspond to N 2D plans acquired by dividing a 3D plan of a sculpture, which is to be produced, in a random direction, respectively, such that the shapes of the corresponding regions of the sculpture are formed and stacked on the respective transparent plates;
one or more representation materials selected from a representation material stacked on the corresponding transparent plate so as to form the shape of the corresponding region on the corresponding transparent plate, a representation material to be joined, and a representation material of a scratch formed to represent the shape;
a plurality of transparent supports each fixedly installed on one side of the corresponding transparent plate so as to stack the transparent plate;
a containing frame made of a transparent material, and configured to contain components of the sculpture having the transparent plates stacked therein; and
a transparent material filling the internal space of the containing frame.

2. The sculpture of claim 1, wherein the representation material comprises any one or more materials selected from an artificially produced material and a natural material acquired from nature.

3. A method for producing a sculpture in a 3D transparent space, the method comprising:
(a) preparing a 3D plan of a sculpture;
(b) acquiring N 2D plans by dividing the 3D plan in a random direction;
(c) preparing a plurality of transparent plates corresponding to the number of the N 2D plans;
(d) forming the shapes of the 2D plans on the respective transparent plates using a representation material, while stacking the N transparent plates; and
(e) putting components of the sculpture, subjected to the shape formation process, into a containing frame, and filling the empty space of the containing frame with a transparent material.

4. The method of claim 3, wherein the step (d) comprises stacking the representation material on the corresponding transparent plate, joining the representation material to the corresponding transparent plate or scratching or cutting the corresponding transparent plate, in order to form the shape of the corresponding region on the transparent plate.

5. The method of claim 3, wherein the representation material comprises any one or more materials selected from an artificially produced material and a natural material acquired from nature.

6. The method of claim 5, wherein the artificial material is an independent object made of iron or plastic.

7. The method of claim 5, wherein the natural material is a plant, mineral or animal.

8. The method of claim 4, wherein the scratching of the transparent plate is performed by a laser device.

9. The method of claim 4, wherein the representation material comprises any one or more materials selected from an artificially produced material and a natural material acquired from nature.

10. The method of claim 9, wherein the artificial material is an independent object made of iron or plastic.

11. The method of claim 9, wherein the natural material is a plant, mineral or animal.
